(19) United States
(12) Patent Application Publication
(10) Pub. No.: US 2026/0172952 A1
(43) Pub. Date: Jun. 18, 2026

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/532,315

(22) Filed: Feb. 6, 2026

Related U.S. Application Data
(63) Continuation of application No. PCT/JP2024/028546, filed on Aug. 8, 2024.

(30) Foreign Application Priority Data
Aug. 9, 2023 (JP) 2023-130079

(51) Int. Cl. H04W 48/16; H04W 24/10; H04W 76/10

(52) U.S. Cl. CPC H04W 48/16; H04W 24/10; H04W 76/10

(57) ABSTRACT

In an aspect, a communication control method is a communication control method used in a cellular communication system. The communication control method includes transmitting, by a user equipment, a first connection request notification to a base station, the first connection request notification indicating a desire to connect to a mobile Integrated Access and Backhaul (IAB) cell. The communication control method also includes transmitting, by the base station, a first message to the user equipment in response to receiving the first connection request notification, the first message including a first measurement configuration that enables the user equipment to measure the mobile IAB cell.

### RELATED APPLICATIONS

The present application is a continuation based on PCT Application No. PCT/JP2024/028546, filed on Aug. 8, 2024, which claims the benefit of Japanese Patent Application No. 2023-130079 filed on Aug. 9, 2023. The content of which is incorporated by reference herein in their entirety.

### TECHNICAL FIELD

The present disclosure relates to a communication control method used in a cellular communication system.

### BACKGROUND

In the Third Generation Partnership Project (3GPP) (registered trademark, the same applies hereinafter) that is a standardization project for cellular communication systems, the introduction of a new relay node called an Integrated Access and Backhaul (IAB) node is being considered (see, for example, Non-Patent Document 1). One or more relay nodes are involved in communication between a base station and a user equipment and perform relay for the communication.

### CITATION LIST

### Non-Patent Literature

Non-patent Document 1: 3GPP TS 38.300 V17.5.0 (2023-06)

### SUMMARY

In a first aspect, a communication control method is a communication control method used in a cellular communication system. The communication control method includes transmitting, by a user equipment, a first connection request notification to a base station, the first connection request notification indicating a desire to connect to a mobile IAB cell. The communication control method also includes transmitting, by the base station, a first message to the user equipment in response to receiving the first connection request notification, the first message including a measurement configuration that enables the user equipment to measure the mobile IAB cell.

In a second aspect, a communication control method is a communication control method used in a cellular communication system. The communication control method includes transmitting, by a user equipment, a second connection request notification to a mobile IAB cell, the second connection request notification indicating a desire to connect to a base station. The communication control method also includes transmitting, by the mobile IAB cell, a third message to the user equipment in response to receiving the second connection request notification, the third message including a measurement configuration that enables the user equipment to measure the base station.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, Parent nodes, and Child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a user equipment (UE) according to the embodiment.

FIG. 6 is a diagram illustrating an example of a protocol stack related to RRC connection and NAS connection of an IAB-MT.

FIG. 7 is a diagram illustrating an example of a protocol stack relating to an F1-U protocol.

FIG. 8 is a diagram illustrating an example of a protocol stack relating to an F1-C protocol.

FIG. 9 is a diagram illustrating a use case according to a first embodiment.

FIG. 10 is a diagram illustrating an operation example according to the first embodiment.

FIG. 11 is a diagram illustrating an operation example according to a second embodiment.

### DESCRIPTION OF EMBODIMENTS

The present disclosure has an object to enable a cell to transmit a measurement configuration to a user equipment at an appropriate timing.

A cellular communication system according to embodiments will be described with reference to the drawings. In the description of the drawings, the same or similar parts are denoted by the same or similar reference signs.

### First Embodiment

### Configuration of Cellular Communication System

A configuration example of the cellular communication system according to an embodiment will be described. A cellular communication system 1 according to the embodiment is a 3GPP 5G system. Specifically, a radio access scheme in the cellular communication system 1 is a New Radio (NR) being a 5G radio access scheme. Note that Long Term Evolution (LTE) may be at least partially applied to the cellular communication system 1. A future cellular communication system such as 6G may be also applied to the cellular communication system 1.

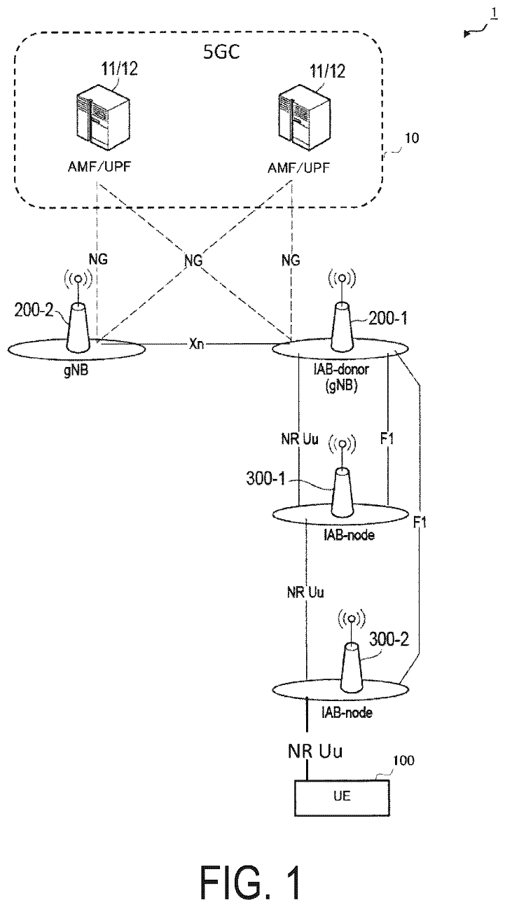

FIG. 1 is a diagram illustrating a configuration example of the cellular communication system 1 according to the embodiment.

As illustrated in FIG. 1, the cellular communication system 1 includes a 5G core network (5GC) 10, a User Equipment (UE) 100, base station apparatuses (hereinafter may be referred to as “base stations”) 200-1 and 200-2, and IAB nodes 300-1 and 300-2. A base station 200 may be referred to as a gNB.

In the following, an example in which the base station 200 is an NR base station will be mainly described, but the base station 200 may also be an LTE base station (that is, an eNB).

In the following, the base stations 200-1 and 200-2 may be referred to as the gNBs 200 (or base station 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 is an apparatus that performs various mobility control for the UE 100. The AMF 11 communicates with the UE 100 using Non-Access Stratum (NAS) signaling to manage information on an area in which the UE 100 exists. The UPF 12 is an apparatus that performs transfer control of user data, and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. One cell belongs to one carrier frequency. Hereinafter, a cell and a base station may be used without distinction.

Each gNB 200 is interconnected with the 5GC 10 via an interface referred to as an NG interface. FIG. 1 illustrates the two gNB 200-1 and gNB 200-2, connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU, and includes an F1-C protocol, which is a control plane protocol, and an F1-U protocol, which is a user plane protocol.

The cellular communication system 1 supports IAB, which enables radio relay of NR access using an NR for backhaul. A donor gNB 200-1 (or a donor node, hereinafter sometimes referred to as a “donor node”) is a donor base station that is a terminal node of the NR backhaul on the network side and includes additional functionality for supporting the IAB. The backhaul is capable of multi-hopping via a plurality of hops (that is, a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted by two backhaul hops.

The UE 100 is a wireless communication apparatus that is movable and performs wireless communication with a cell. The UE 100 may be any apparatus that performs wireless communication with the gNB 200 or the IAB node 300. For example, the UE 100 is a mobile phone terminal or a tablet terminal, a notebook PC, a sensor or an apparatus provided in a sensor, a vehicle or an apparatus provided in a vehicle, or an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

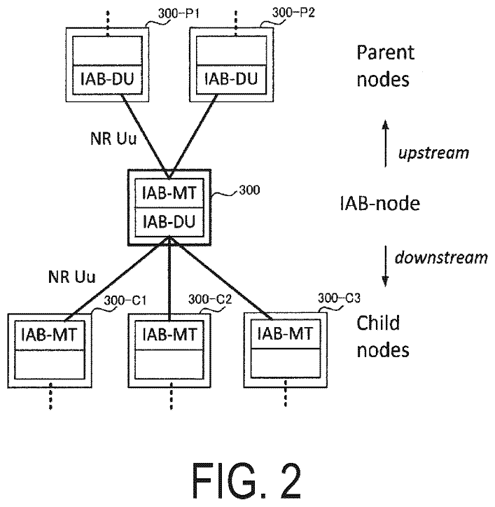

FIG. 2 is a diagram illustrating an example of a relationship between the IAB node 300, Parent nodes, and Child nodes.

As illustrated in FIG. 2, each IAB node 300 includes an IAB-DU equivalent to a base station function unit and an IAB-MT (Mobile Termination) equivalent to a user equipment function unit.

Adjacent nodes (that is, upper nodes) on an NR Uu radio interface of the IAB-MT are referred to as parent nodes. The parent node is a DU of a parent IAB node or the donor node 200. A radio link between the IAB-MT and the parent node is referred to as a backhaul link (BH link). FIG. 2 illustrates an example in which the parent nodes of the IAB node 300 are IAB nodes 300-P1 and 300-P2. A direction toward the parent nodes is referred to as upstream. From the perspective of the UE 100, the upper node of the UE 100 may correspond to a parent node.

Adjacent nodes (that is, lower nodes) on the NR access interface of the IAB-DU are referred to as child nodes. The IAB-DU manages the cell similarly to the gNB 200. The IAB-DU terminates the NR Uu radio interface to the UE 100 and the lower IAB nodes. The IAB-DU supports the F1 protocol to the CU of the donor node 200-1. FIG. 2 illustrates an example in which the child nodes of the IAB node 300 are IAB nodes 300-C1 to 300-C3, but the child node of the IAB node 300 may also include the UE 100. A direction toward the child nodes is referred to as downstream.

All of the IAB nodes 300 connected to the donor node 200 via one or more hops form a Directed Acyclic Graph (DAG) topology (hereinafter may be referred to as “topology”) with the donor node 200 as the root. In this topology, as illustrated in FIG. 2, adjacent nodes on the IAB-DU interface are child nodes, and adjacent nodes on the IAB-MT interface are parent nodes. The donor node 200 performs central management including resource, topology, and route management of the IAB topology. The donor node 200 is a gNB that provides network access to the UE 100 via a network of backhaul links and access links.

### Configuration of Base Station

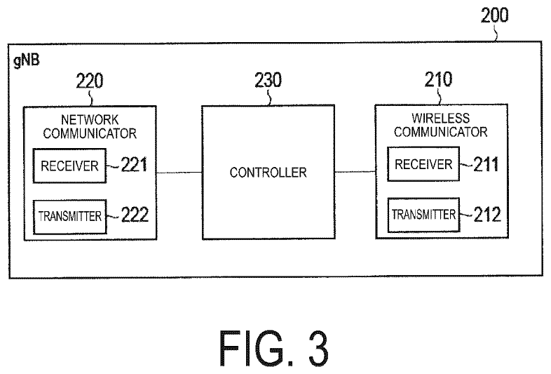

A configuration of the gNB 200, which is a base station according to the embodiment, will be described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and wireless communication with the IAB node 300. The wireless communicator 210 includes a receiver 211 and a transmitter 212. The receiver 211 performs various types of reception under the control of the controller 230. The receiver 211 includes an antenna, and converts (down-converts) a radio signal received by the antenna into a baseband signal (reception signal) and outputs the signal to the controller 230. The transmitter 212 performs various types of transmission under the control of the controller 230. The transmitter 212 includes an antenna, and converts (up-converts) a baseband signal (transmission signal) output by the controller 230 into a radio signal and transmits the signal from the antenna.

The network communicator 220 performs wired communication (or wireless communication) with the 5GC 10 and wired communication (or wireless communication) with the other adjacent gNBs 200. The network communicator 220 includes a receiver 221 and a transmitter 222. The receiver 221 performs various types of reception under the control of the controller 230. The receiver 221 receives a signal from the outside and outputs the reception signal to the controller 230. The transmitter 222 performs various types of transmission under the control of the controller 230. The transmitter 222 transmits a transmission signal output by the controller 230 to the outside.

The controller 230 performs various types of control for the gNB 200. The controller 230 includes at least one memory and at least one processor electrically connected to the memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 230 may perform all of the processing and operations in the gNB 200 in each embodiment to be described below.

### Configuration of Relay Node

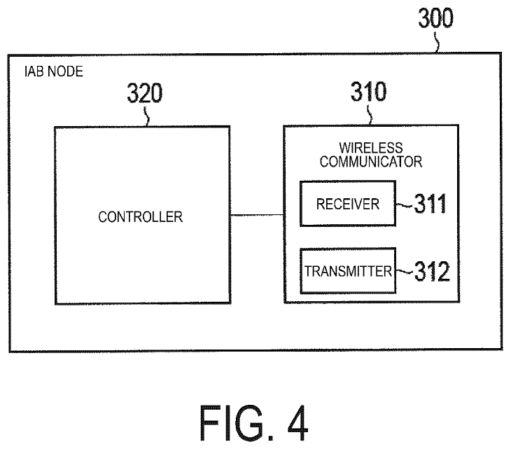

A configuration of the IAB node 300 that is a relay node (or a relay node apparatus, hereinafter sometimes referred to as a “relay node”) according to the embodiment, will be described. FIG. 4 is a diagram illustrating a configuration example of the IAB node 300. As illustrated in FIG. 4, the IAB node 300 includes a wireless communicator 310 and a controller 320. The IAB node 300 may include a plurality of the wireless communicators 310.

The wireless communicator 310 performs wireless communication (BH link) with the gNB 200 and wireless communication (access link) with the UE 100. The wireless communicator 310 for BH link communication and the wireless communicator 310 for access link communication may be provided separately.

The wireless communicator 310 includes a receiver 311 and a transmitter 312. The receiver 311 performs various types of reception under the control of the controller 320. The receiver 311 includes an antenna, and converts (down-converts) a radio signal received by the antenna into a baseband signal (reception signal) and outputs the converted signal to the controller 320. The transmitter 312 performs various types of transmission under the control of the controller 320. The transmitter 312 includes an antenna, and converts (up-converts) a baseband signal (transmission signal) output by the controller 320 into a radio signal and transmits the converted signal from the antenna.

The controller 320 performs various types of control in the IAB node 300. The controller 320 includes at least one memory and at least one processor electrically connected to the memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 320 may perform all of the processing and operations in the IAB node 300 in each embodiment to be described below.

### Configuration of User Equipment

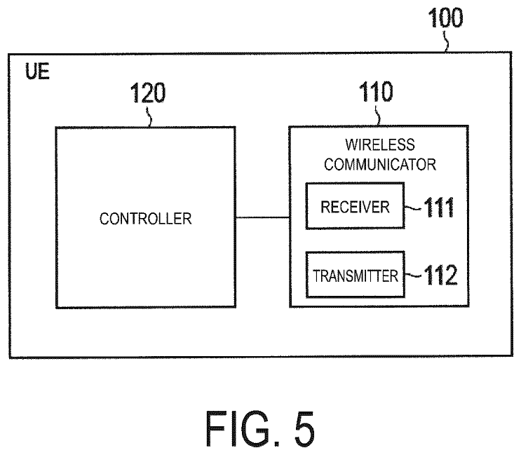

A configuration of the UE 100, which is a user equipment according to the embodiment, will be described. FIG. 5 is a diagram illustrating a configuration example of the UE 100. As illustrated in FIG. 5, the UE 100 includes a wireless communicator 110 and a controller 120.

The wireless communicator 110 performs wireless communication in an access link, that is, wireless communication with the gNB 200 and wireless communication with the IAB node 300. The wireless communicator 110 may also perform wireless communication in a side link, that is, wireless communication with the other UEs 100. The wireless communicator 110 includes a receiver 111 and a transmitter 112. The receiver 111 performs various types of reception under the control of the controller 120. The receiver 111 includes an antenna, and converts (down-converts) a radio signal received by the antenna into a baseband signal (reception signal) and outputs the converted signal to the controller 120. The transmitter 112 performs various types of transmission under the control of the controller 120. The transmitter 112 includes an antenna, and converts (up-converts) a baseband signal (transmission signal) output by the controller 120 into a radio signal and transmits the converted signal from the antenna.

The controller 120 performs various types of control in the UE 100. The controller 120 includes at least one memory and at least one processor electrically connected to the memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 120 may perform all of the processing in the UE 100 in each embodiment to be described below.

### Configuration of Protocol Stack

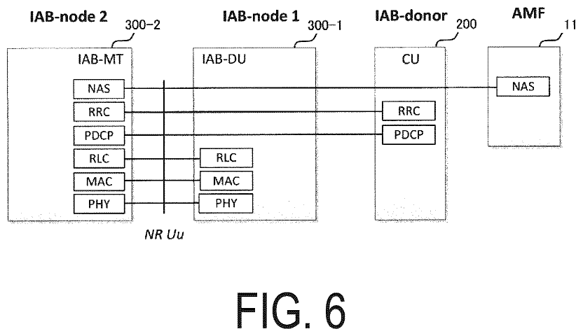

A configuration of a protocol stack according to the embodiment will be described. FIG. 6 is a diagram illustrating an example of a protocol stack relating to RRC connection and NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs encoding/decoding, modulation/demodulation, antenna mapping/demapping, and resource mapping/demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines a transport format (a transport block size and a Modulation and Coding Scheme (MCS)) and assigned resource blocks for an uplink and a downlink.

The RLC layer transmits data to the RLC layer on the receiving side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression/decompression and encryption/decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When an RRC connection with the donor node 200 is present, the IAB-MT is in an RRC connected state. When no RRC connection with the donor node 200 is present, the IAB-MT is in an RRC idle state.

The NAS layer, which is located above the RRC layer, performs session management, mobility management, and the like. NAS signaling is transmitted between the NAS layer of the IAB-MT of the IAB node 300-2 and the AMF 11.

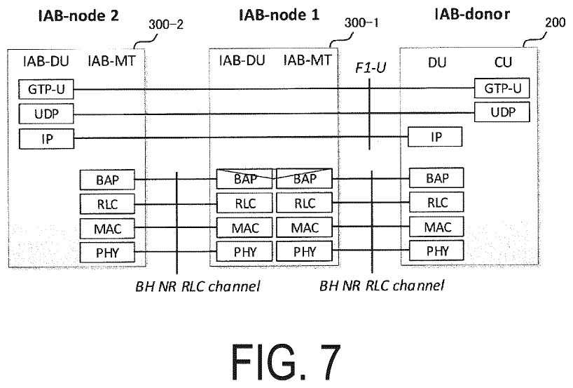

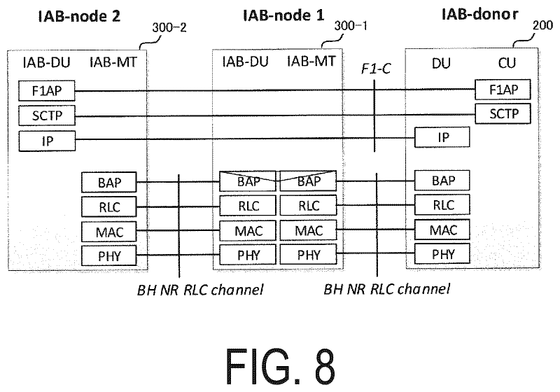

FIG. 7 is a diagram illustrating a protocol stack relating to the F1-U protocol. FIG. 8 is a diagram illustrating a protocol stack relating to the F1-C protocol. Here, an example in which the donor node 200 is divided into a CU and a DU is illustrated.

As illustrated in FIG. 7, the IAB-MT of the IAB node 300-2, the IAB-DU of the IAB node 300-1, the IAB-MT of the IAB node 300-1, and the DU of the donor node 200 each include a Backhaul Adaptation Protocol (BAP) layer as an upper layer of the RLC layer. The BAP layer is a layer for performing a routing process and a bearer mapping/demapping process. In the backhaul, the IP layer is transmitted via the BAP layer, which allows routing by a plurality of hops.

In each backhaul link, a Protocol Data Unit (PDU) of the BAP layer is transmitted by a backhaul RLC channel (BH NR RLC channel). A plurality of backhaul RLC channels is configured in each BH link, thus enabling traffic prioritization and Quality of Service (QoS) control. The PDU of the BAP is associated with the backhaul RLC channel by the BAP layer of each IAB node 300 and the BAP layer of the donor node 200.

As illustrated in FIG. 8, the protocol stack of the F1-C protocol includes an F1AP layer and an SCTP layer instead of a GTP-U layer and an UDP layer illustrated in FIG. 7.

In the following, processes or operations performed in the IAB-DU and IAB-MT of the IAB may be simply described as processes or operations of the “IAB”. For example, the transmission of a message of the BAP layer to the IAB-MT of the IAB node 300-2 by the IAB-DU of the IAB node 300-1 will be described as the transmission of the message to the IAB node 300-2 by the IAB node 300-1. Processing or operations of the DU or CU of the donor node 200 may also be described simply as processing or operations of the “donor node”.

An upstream direction and an uplink (UL) direction may be used without distinction. A downstream direction and a downlink (DL) direction may be used without distinction.

### Mobile IAB Node

At present, 3GPP has started to study the introduction of a mobile IAB node. The mobile IAB node is, for example, an IAB node that is moving. The mobile IAB node may be a movable IAB node. The mobile IAB node may be an IAB node that is capable of moving. The mobile IAB node may be an IAB node that is currently stationary but is certain to move in the future (or is expected to move in the future).

The mobile IAB node allows, for example, the UE 100 under the control of the mobile IAB node to receive services from the mobile IAB node while moving according to the movement of the mobile IAB node. For example, a case is assumed in which a user (or UE 100) riding a vehicle receives services via a mobile IAB node installed in the vehicle.

On the other hand, in contrast to the mobile IAB node, an IAB node that does not move also exists. Such an IAB node may be referred to as an intermediate IAB node. The intermediate IAB node is, for example, an IAB node that does not move. The intermediate IAB node may be an IAB node that is stationary. The intermediate IAB node may be a stationary IAB node. The intermediate IAB node may be an IAB node that is stationary (or does not move) in a state of being installed at its installation location. The intermediate IAB node may be a stationary IAB node that does not move. The intermediate IAB node may be a fixed IAB node.

The mobile IAB node can also be connected to the intermediate IAB node. The mobile IAB node can also be connected to the donor node 200. The mobile IAB node can also change its connection destination due to its movement (migration or handover). A connection source may be the intermediate IAB node. The connection source may be the donor node 200. The connection destination may be the intermediate IAB node. The connection destination may be the donor node 200.

In the following, the movement (migration) of the mobile IAB node and the handover of the mobile IAB node may be used without distinction.

In the following, a mobile IAB node may be a “mobile IAB node”. The mobile IAB node may be a “migrating IAB node”. In either case, the node may be referred to as a mobile IAB node. The mobile IAB node may be a movable relay node.

### Handover According to First Embodiment

One mobility control of the UE 100 in the RRC connected state is handover. Handover is, for example, a technology in which the UE 100 switches the cell to which it is connected. By the handover, for example, the UE 100 can connect to a cell with good radio quality and receive the provision of a service.

The UE 100 measures the radio quality between the UE 100 and the cell in accordance with the measurement configuration (MeasConfig) received from the gNB 200. The measurement configuration includes configuration information for the UE 100 to perform measurement processing and transmit a measurement report to the gNB 200. The measurement configuration is transmitted from the gNB 200 to the UE 100 using dedicated signaling (RRC messages such as an RRC reconfiguration message or an RRC resume message).

The measurement configuration includes a measurement object (MeasObject), a report configuration (ReportConfig), a measurement ID (MeasID), and a measurement gap (MeasGap).

The measurement object may include information for specifying the measurement object. Specifically, the measurement object may include information indicating whether the measurement object is a synchronization signal block (SSB), a channel state information reference signal (CSI-RS), or both a synchronization signal block and a channel state information reference signal. The measurement object may include the frequency of a synchronization signal block (SSB) to be measured, or the frequency of a channel state information reference signal to be measured. The measurement object may include, for example, information indicating frequency and time position of the measurement object. The measurement object may include a list of cells to be measured (white list) and/or a list of cells not to be measured (black list).

The report configuration includes information for specifying a criterion for triggering a measurement report. Specifically, the report configuration may include information such as reporting intervals when the measurement report is periodically performed. The report configuration may include information related to each event (for example, each event, and a threshold value, an offset value, and/or a hysteresis value used in each event) when the measurement report is performed with an event trigger. Examples of such events include an event in which a connected cell (serving cell) becomes better than a threshold value (event A1), an event in which the serving cell becomes worse than the threshold value (event A2), an event in which a neighboring cell becomes better than the serving cell by an offset (event A3), an event in which a neighboring cell becomes better than the threshold value (event A4), and an event in which the serving cell becomes worse than a first threshold value and a neighboring cell becomes better than a second threshold value (event A5). The report configuration may include information indicating which is used as a target of measurement quality (received quality), out of received power (Reference Signal Received Power (RSRP)), Reference Signal Received Quality (RSRQ), and Signal to Interference plus Noise Ratio (SINR).

The measurement ID is used for identifying the configuration information (MeasurementConfig), and links the measurement object and the measurement report to each other.

The measurement gap includes information for configuring a time period (measurement gap) in which measurement is performed in the UE 100.

The UE 100 that receives the measurement configuration measures the received quality of the cells according to the measurement configuration. The UE 100 may measure at least one beam of the cell and average measurement results to measure the received quality. The UE 100 transmits the measurement report including the received quality as measurement results (MeasResults) to the gNB 200 in accordance with the measurement configuration.

In the gNB 200, a decision to perform handover (Handover Decision) is made based on the received quality. When the gNB 200 determines to execute handover, the gNB 200 transmits, to the UE 100, an RRC message (e.g., an RRC Reconfiguration message) (or a handover command) including information necessary to access the target cell. By receiving the RRC message, the UE 100 knows that handover is possible, and can start connection to the target cell by using the information included in the RRC message.

### Communication Control Method According to First Embodiment

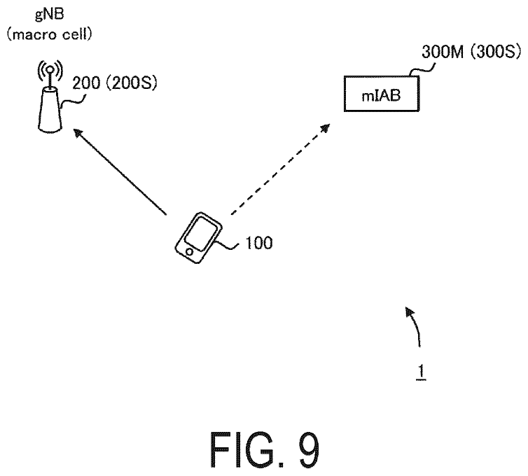

FIG. 9 is a diagram illustrating an example of a use case according to the first embodiment.

As illustrated in FIG. 9, the gNB 200 is a fixed base station that does not move. The gNB 200 manages (or accommodates) a macrocell 200S. Hereinafter, the gNB 200 and the macrocell 200S may be used without distinction. In this case, the UE 100 is in an RRC connected state with the macrocell 200S.

For example, the following situation is assumed. That is, the UE 100 enters a mobile vehicle such as a train or a bus. The mobile vehicle is provided with a mobile IAB node 300M. The mobile IAB node 300M has a cell that it manages (or accommodates). This cell may be referred to as a mobile IAB cell (or a mobile IAB cell 300S). On the other hand, the macrocell 200S transmits a measurement configuration (MeasConfig) to the UE 100. The measurement configuration includes information related to the mobile IAB cell 300S, such as a cell ID of the mobile IAB cell 300S and a frequency used in the mobile IAB cell 300S.

Given the above assumption, for example, the UE 100 can transmit a measurement report that targets the mobile IAB cell 300S as a measurement object by using information related to the mobile IAB cell 300S included in the measurement configuration. This enables the UE 100 to perform handover to the mobile IAB cell 300S.

However, the mobile IAB cell 300S (and the mobile IAB node 300M) moves. In the macrocell 200S, it is not known at which timing the mobile IAB cell 300S flows into the cell and at which timing the mobile IAB cell 300S flows out of the cell. Therefore, the mobile IAB cell 300S is not necessarily located in an area close to the macrocell 200S as illustrated in FIG. 9. Even if the mobile IAB cell 300S is not located in an area close to the macrocell 200S, and the macrocell 200S transmits a measurement configuration (MeasConfig) including information related to the mobile IAB cell 300S to the UE 100, the measurement processing for the mobile IAB cell 300S may be wasted in the UE 100, resulting in unnecessary power consumption. Furthermore, the resources used to transmit the measurement configuration (MeasConfig) may also be wasted.

On the other hand, even if the mobile IAB cell 300S is located in an area close to the macrocell 200S, for example, the UE 100 may be located at the side of a road or a railroad track rather than entering a mobile vehicle. In such a case, it is conceivable that the UE 100 does not need to transmit a measurement report for the mobile IAB cell 300S.

Therefore, the first embodiment has an object to enable the cell to transmit the measurement configuration to the UE 100 at an appropriate timing.

Therefore, in the first embodiment, the user equipment (e.g., the UE 100) first transmits, to the base station (e.g., the macrocell 200S), a first connection request notification indicating a desire to connect to a mobile IAB cell (e.g., the mobile IAB cell 300S). Second, in response to receiving the first connection request notification, the base station transmits, to the user equipment, a first message including a measurement configuration (e.g., a measurement configuration (MeasConfig)) that enables the user equipment to measure the mobile IAB cell.

In this way, the macrocell 200S can confirm that the UE 100 desires to connect to the mobile IAB cell 300S by receiving the connection request notification to the mobile IAB cell 300S. Therefore, in the macrocell 200S, for example, by transmitting a measurement configuration (MeasConfig) at the timing when it is confirmed that the UE 100 desires to connect to the mobile IAB cell 300S, it is possible to avoid transmitting the measurement configuration to a UE 100 that does not desire to connect to the mobile IAB cell 300S, and to transmit the measurement configuration at an appropriate timing. Furthermore, since the UE 100 can transmit a measurement report that targets the mobile IAB cell 300S as a measurement object in accordance with the measurement configuration (MeasConfig), handover to the mobile IAB cell 300S is also possible.

Current 3GPP specifications include a technology called “Proximity Indication” (for example, 3GPP TS 36.300 V17.5.0 and 3GPP TS 36.331 V17.5.0). The proximity indication is a technology in which, when the UE 100 in an RRC connected state detects proximity to a CSG member cell (including a HeNB (Home evolved Node B)) using an autonomous search procedure, the UE 100 transmits a proximity indication to the serving cell, thereby receiving a measurement configuration (Measurement Config) from the serving cell. The measurement configuration enables the UE 100 to transmit a measurement report that targets a CSG member cell as a report target, thereby enabling handover to the CSG member cell.

However, the CSG member cell is assumed to be a fixed cell, and is not intended for the mobile IAB cell 300S, which is movable. Therefore, when the distance to the mobile IAB cell 300S is the same between a UE 100 boarding on a mobile vehicle and a UE 100 beside the railroad track, if a proximity indication is used, the UE 100 beside the railroad track also transmits a measurement report to the mobile IAB cell 300S based on the measurement configuration received from the macrocell 200S. Therefore, the measurement processing for the mobile IAB cell 300S in the UE 100 may be wasted.

In this way, in the proximity indication, even the UE 100 that does not need to report a measurement report to the mobile IAB cell 300S may receive measurement configurations from the macrocell 200S. Therefore, it may not be said that the measurement configurations are received from the macrocell 200S at the appropriate timing.

### Operation Example According to First Embodiment

Next, an operation example according to the first embodiment will be described.

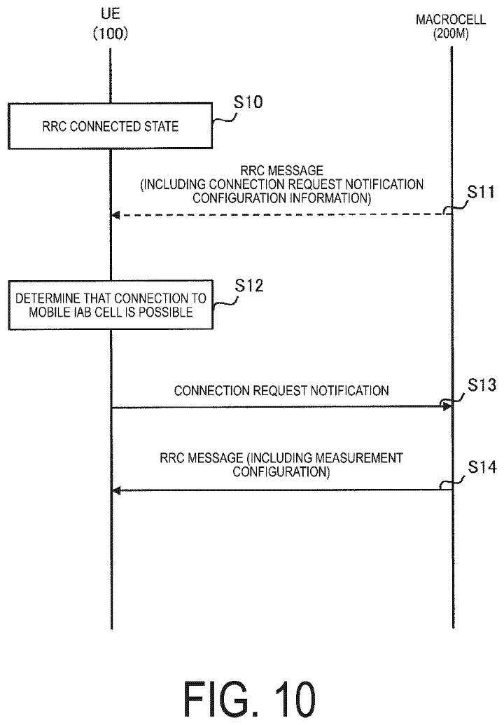

FIG. 10 is a diagram illustrating an operation example according to the first embodiment. It is assumed that before the operation example illustrated in FIG. 10 is started, the situation is as illustrated in FIG. 9, for example. That is, it is assumed that the UE 100 is connected to the macrocell 200S with the macrocell 200S as a serving cell.

As illustrated in FIG. 10, in step S10, the UE 100 is in an RRC connected state with the macrocell 200S.

In step S11, the macrocell 200S may configure the UE 100 to transmit a connection request notification (for example, a first connection request notification). Specifically, the macrocell 200S may transmit, to the UE 100, an RRC message (e.g., a second message) including information including a transmission configuration of a connection request notification (in the first embodiment, this may be referred to as “connection request notification configuration information” or first connection request notification configuration information).

First, the macrocell 200S may configure the transmission of a connection request notification in response to the inflow of the mobile IAB cell 300S into its area. The macrocell 200S may perform this configuration in response to receiving a message (e.g., an Xn message) including information indicating that the mobile IAB cell 300S has flowed into its own cell from an adjacent gNB (which may be, for example, the donor node (IAB-donor) of the mobile IAB node 300M). The macrocell 200S may perform this configuration in response to receiving a message (e.g., an NG message) including information indicating that the mobile IAB cell 300S has flowed into its own cell from a core network apparatus (e.g., the AMF 11).

Second, the connection request notification configuration information may include information related to the mobile IAB cell 300S. The information related to the mobile IAB cell 300S may be the cell ID of the mobile IAB cell 300S. The information related to the mobile IAB cell 300S may be identification information used for access restriction in the mobile IAB cell 300S. The identification information may be any of a closed access group ID (CAG ID), a public land mobile network ID (PLMN ID), a public network integrated non-public network (PNI-NPN ID), a standalone non-public network ID (SNPN ID), a network identifier (NID), and a tracking area code (TAC). In a subsequent step S13, the UE 100 may transmit a connection request notification when it desires to connect to the mobile IAB cell 300S that matches the information related to the mobile IAB cell 300S.

The RRC message used in step S11 may be an RRC reconfiguration message.

In step S12, the UE 100 determines that it is possible to connect to the mobile IAB cell 300S.

First, whether connection is possible may be determined based on whether the UE 100 is to camp on the mobile IAB cell 300S. When the AS of the UE 100 detects, based on information received from an upper layer, that the UE 100 has boarded a mobile vehicle, which is movable, the AS may determine that the UE 100 is to camp on the mobile IAB cell 300S (that is, determine that connection is possible). Specifically, when the AS of the UE 100 receives, via the NAS, information indicating that the UE 100 has entered a train equipped with a mobile IAB cell 300S by a specific application service (for example, a fare payment system or application using near field communication (NFC)), the AS determines that the UE 100 is to camp on the mobile IAB cell 300S (that is, determines that connection is possible). When the AS of the UE 100 detects that its own moving speed is equal to or greater than a predetermined speed, the AS may determine that the UE 100 is to camp on the mobile IAB cell 300S (that is, determine that connection is possible). The AS of the UE 100 may acquire its own moving speed using a speed sensor or the like. The predetermined speed may be configured by an RRC message or the like from the macrocell 200S.

Second, whether connection is possible may be determined based on whether the UE 100 detects a mobile IAB cell type indication (mIAB cell type indication or mIAB-cell indication). The mobile IAB cell type indication is, for example, an indication that the cell is a mobile IAB cell 300S. The mobile IAB cell type indication is included in, for example, system information (e.g., SIB1) broadcast from the mobile IAB cell 300S. The UE 100 may determine that it is possible to connect to the mobile IAB cell 300S by continuing to detect the mobile IAB cell type indication for a certain period of time or more. The UE 100 may configure the certain period of time by receiving an RRC message (for example, an RRC reconfiguration message) including the certain period of time from the macrocell 200S.

Whether connection is possible may be determined depending on the implementation of the UE 100.

In step S13, when the UE 100 determines that connection to the mobile IAB cell 300S is possible, the UE 100 transmits a connection request notification (for example, a first connection request notification) to the macrocell 200S.

First, the determination that connection is possible may be the determination in step S12 that connection is possible. The determination that connection is possible may be a determination that the UE 100 is to connect to the mobile IAB cell 300S. The AS of the UE 100 may determine that the UE 100 is to connect by receiving a notification from an upper layer that the UE 100 should connect to the mobile IAB cell 300S.

Second, the connection request notification may be a notification of a desire for measurement configuration including the frequency used in the mobile IAB cell 300S and/or the cell ID of the mobile IAB cell 300S. The connection request notification may be a notification that a handover to a frequency used in the mobile IAB cell 300S is desired and/or a notification that a handover to the mobile IAB cell 300S is desired. The connection request notification may be a notification that the UE 100 is located in the vicinity of the mobile IAB cell 300S. The connection request notification may be a notification that the UE 100 has entered a mobile vehicle. The connection request notification may be a notification that the UE 100 desires a measurement configuration that enables the UE 100 to measure the mobile IAB cell 300S (or the frequency used in the mobile IAB cell 300S).

Third, the connection request notification may include at least any selected from the group consisting of the frequency used in the mobile IAB cell 300S, the cell ID of the mobile IAB cell 300S, and identification information used for access restriction in the mobile IAB cell 300S. The UE 100 may use at least any of the frequency, the cell ID, and the identification information included in the connection request notification configuration information received in step S11 to transmit a connection request notification including at least any selected from the group consisting of the frequency, the cell ID, and the identification information. The connection request notification may include position information of the UE 100. In the macrocell 200S, when the position of the mobile IAB cell 300S is known, it is possible to select an appropriate mobile IAB cell 300S based on the position information acquired from the UE 100 and transmit, to the UE 100, a measurement configuration that enables the mobile IAB cell 300S to be the measurement object. The UE 100 may acquire the position information using the GNSS receiver. The UE 100 may acquire the position information based on a Positioning Referencing Signal (PRS) received from the macrocell 200S.

The UE 100 may transmit an RRC message including a connection request notification. The UE 100 may transmit a MAC control element (MAC CE) including a connection request notification. The UE 100 may transmit a downlink control signal (DCI) including a connection request notification. Furthermore, the UE 100 may receive connection request notification configuration information (step S11) and transmit the connection request notification in accordance with the configuration information.

In step S14, in response to receiving the connection request notification, the macrocell 200S transmits an RRC message (e.g., a first message) including a measurement configuration (MeasConfig) to the UE 100. The measurement configuration includes, for example, the frequency of the mobile IAB cell 300S and/or the cell ID of the mobile IAB cell 300S. The measurement configuration can be, for example, a measurement configuration that enables the UE 100 to measure the mobile IAB cell 300S. Instead of transmitting an RRC message including the measurement configuration, the macrocell 200S may transmit an RRC message indicating a handover command (e.g., an RRC reconfiguration message) to the UE 100. The RRC message includes information necessary for the UE 100 to access the mobile IAB cell 300S, and the UE 100 can perform handover (or connection) to the mobile IAB cell 300S based on the information.

After receiving the measurement configuration, the UE 100 performs measurement processing on the mobile IAB cell 300S in accordance with the measurement configuration, and transmits the measurement result to the macrocell 200S as a measurement report. Upon receiving the measurement report, the macrocell 200S decides to perform a handover and transmits an RRC reconfiguration message (or a handover command) to the UE 100. The UE 100 uses the information included in the RRC reconfiguration message to start connection to the mobile IAB cell 300S.

### Second Embodiment

A second embodiment will be described. In the second embodiment, differences from the first embodiment will be mainly described.

In the first embodiment, an example has been described in which the UE 100 transmits a connection request notification to the macrocell 200S, the macrocell 200S transmits a message including a measurement configuration to the UE 100, and the UE 100 performs handover from the macrocell 200S to the mobile IAB cell 300S. In the second embodiment, an example will be described in which the UE 100 transmits a connection request notification to the mobile IAB cell 300S, the mobile IAB cell 300S transmits a message including a measurement configuration, and the UE 100 performs handover from the mobile IAB cell 300S to the macrocell 200S.

Specifically, first, the user equipment (e.g., the UE 100) transmits a second connection request notification indicating a desire to connect to the base station (e.g., the macrocell 200S) to the mobile IAB cell (e.g., the mobile IAB cell 300S). Second, in response to receiving the second connection request notification, the mobile IAB cell transmits, to the user equipment, a third message (e.g., an RRC message) including a measurement configuration (e.g., a measurement configuration (MeasConfig)) that enables the user equipment to measure the base station.

Accordingly, for example, the mobile IAB cell 300S can transmit the measurement configuration to the UE 100 in response to receiving a connection request notification from the UE 100, and thus transmit the measurement configuration to the UE 100 at the timing when it is confirmed that the UE 100 desires to connect to the macrocell 200S. Therefore, the mobile IAB cell 300S can transmit the measurement configuration to the UE 100 at an appropriate timing.

### Operation Example According to Second Embodiment

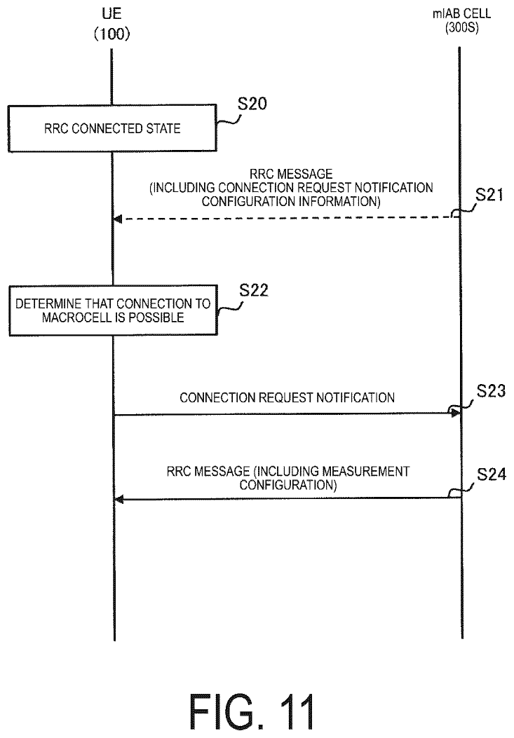

FIG. 11 is a diagram illustrating an operation example according to the first embodiment. The operation example illustrated in FIG. 11 may be performed after the operation example (first embodiment) illustrated in FIG. 10 is performed.

As illustrated in FIG. 11, in step S20, the UE 100 is in an RRC connected state with the mobile IAB cell 300S.

In step S21, the mobile IAB cell 300S may configure the UE 100 to transmit a connection request notification (e.g., a second connection request notification). Specifically, the mobile IAB cell 300S may transmit, to the UE 100, an RRC message (e.g., a fourth message) including information including a transmission configuration of a connection request notification (in the second embodiment, this may be referred to as “connection request notification configuration information” or second connection request notification configuration information). The connection request notification configuration information may include the cell ID of the macrocell 200S, or may include identification information (such as a CAG ID) used for access restriction in the macrocell 200S.

In step S22, the UE 100 determines that it is possible to connect to the macrocell 200S. For example, when the AS of the UE 100 detects that the UE 100 has gotten off a movable vehicle based on information received from an upper layer, the AS of the UE 100 may determine that the UE 100 can connect to the macrocell 200S. Specifically, when the AS of the UE 100 receives, via NAS, information indicating that the UE 100 has gotten off a train equipped with a mobile IAB cell 300S by a specific application service (e.g., a fare payment system or application using NFC), the AS of the UE 100 may determine that the UE 100 can connect to the macrocell 200S. The AS of the UE 100 may determine that the UE 100 can connect to the macrocell 200S when detecting that its own moving speed is less than a predetermined speed. The predetermined speed may be configured by an RRC message from the mobile IAB cell 300S. Whether the connection is possible may be determined depending on the implementation of the UE 100, similarly to the first embodiment.

In step S23, when the UE 100 determines that connection to the macrocell 200S is possible, the UE 100 transmits a connection request notification (e.g., a second connection request notification) to the mobile IAB cell 300S.

First, the determination that connection is possible may be the determination in step S22 that connection is possible. The determination that connection is possible may be a determination that the UE 100 is to connect to the macrocell 200S. The AS of the UE 100 may determine that the UE 100 should connect by receiving a notification from an upper layer that the UE 100 is to connect to the macrocell 200S.

Second, the connection request notification may be a notification of a desire for measurement configuration including the frequency used in the macrocell 200S and/or the cell ID of the macrocell 200S. The connection request notification may be a notification that a handover to a frequency used in the macrocell 200S is desired and/or a notification that a handover to the macrocell 200S is desired. The connection request notification may be a notification that the UE 100 is located in the vicinity of the mobile IAB cell 300S. The connection request notification may be a notification that the UE 100 has gotten off a mobile vehicle. The connection request notification may be a notification that the UE 100 desires a measurement configuration that enables the UE 100 to measure the macrocell 200S (or the frequency used in the macrocell 200S).

Third, the connection request notification may include at least any selected from the group consisting of the frequency used in the macrocell 200S, the cell ID of the macrocell 200S, and identification information used for access restriction in the macrocell 200S. The UE 100 may use at least any of the frequency, the cell ID, and the identification information included in the connection request notification configuration information received in step S21 to transmit a connection request notification including at least any selected from the group consisting of the frequency, the cell ID, and the identification information. The connection request notification may include position information of the UE 100.

The UE 100 may transmit an RRC message including a connection request notification. The UE 100 may transmit a MAC control element (MAC CE) including a connection request notification. The UE 100 may transmit a downlink control signal (DCI) including a connection request notification. Furthermore, the UE 100 may receive connection request notification configuration information (step S21) and transmit the connection request notification in accordance with the configuration information.

In step S24, in response to receiving the connection request notification, the mobile IAB cell 300S transmits an RRC message (e.g., a third message) including a measurement configuration (MeasConfig) to the UE 100. The measurement configuration can be, for example, a measurement configuration that enables the UE 100 to measure the macrocell 200S. Instead of transmitting an RRC message including the measurement configuration, the mobile IAB cell 300S may transmit an RRC message indicating a handover command (e.g., an RRC reconfiguration message) to the UE 100. The RRC message includes information necessary for the UE 100 to access the macrocell 200S, and the UE 100 can perform handover (or connection) to the macrocell 200S based on the information.

After receiving the measurement configuration, the UE 100 performs measurement processing on the macrocell 200S in accordance with the measurement configuration, and transmits the measurement result to the mobile IAB cell 300S as a measurement report. The mobile IAB cell 300S decides to perform a handover based on the measurement report and transmits an RRC reconfiguration message (or a handover command) to the UE 100. The UE 100 uses the information included in the RRC reconfiguration message to start connection to the macrocell 200S.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps need not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each processing operation performed by the UE 100, the gNB 200, or the mobile IAB node 300M may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Further, circuits for executing processing performed by the UE 100 or the gNB 200 may be integrated, and at least a part of the UE 100, the gNB 200, or the mobile IAB node 300M may be configured as a semiconductor integrated circuit (chipset or system on a chip (SoC)).

The functions achieved by the UE 100, the gNB 200, or the mobile IAB node 300M may be implemented in circuitry or processing circuitry including general purpose processors and special purpose processors that are programmed to achieve the described functions, integrated circuits, application specific integrated circuits (ASICs), a central processing unit (CPU), conventional circuits, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. Similarly, the phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### Supplementary Notes

### Supplementary Note 1

A communication control method used in a cellular communication system, the communication control method including the steps of:
transmitting, by a user equipment, a first connection request notification to a base station, the first connection request notification indicating a desire to connect to a mobile IAB cell; and
transmitting, by the base station, a first message to the user equipment in response to receiving the first connection request notification, the first message including a measurement configuration that enables the user equipment to measure the mobile IAB cell.

### Supplementary Note 2

The communication control method according to Supplementary Note 1, further including the steps of:
transmitting, by the base station, a second message to the user equipment, the second message including first connection request notification configuration information indicating configuration information configured to transmit the first connection request notification; and
receiving, by the user equipment, the second message,
in which the transmitting of the first connection request notification includes transmitting, by the user equipment, the first connection request notification in accordance with the first connection request notification configuration information.

### Supplementary Note 3

The communication control method according to Supplementary Note 1 or 2, in which
the transmitting of the first connection request notification includes transmitting, by the user equipment, the first connection request notification when determining that connection to the mobile IAB cell is possible.

### Supplementary Note 4

The communication control method according to any one of Supplementary Notes 1 to 3, in which
the first connection request notification includes at least any selected from the group consisting of a frequency used in the mobile IAB cell, a cell ID of the mobile IAB cell, and identification information used for access restriction in the mobile IAB cell.

### Supplementary Note 5

A communication control method used in a cellular communication system, the communication control method including the steps of:
transmitting, by a user equipment, a second connection request notification to a mobile IAB cell, the second connection request notification indicating a desire to connect to a base station; and
transmitting, by the mobile IAB cell, a third message to the user equipment in response to receiving the second connection request notification, the third message including a measurement configuration that enables the user equipment to measure the base station.

### Supplementary Note 6

The communication control method according to any one of Supplementary Notes 1 to 5, further including the steps of:
transmitting, by the mobile IAB cell, a fourth message to the user equipment, the fourth message including second connection request notification configuration information indicating configuration information configured to transmit the second connection request notification; and
receiving, by the user equipment, the fourth message,
in which the transmitting of the second connection request notification includes transmitting, by the user equipment, the second connection request notification in accordance with the second connection request notification configuration information.

### Supplementary Note 7

The communication control method according to any one of Supplementary Notes 1 to 6, in which
the transmitting of the second connection request notification includes transmitting, by the user equipment, the second connection request notification when determining that connection to the base station is possible.

### Supplementary Note 8

The communication control method according to any one of Supplementary Notes 1 to 5, in which
the second connection request notification includes at least any selected from the group consisting of a frequency used in the base station, a cell ID of the base station, and identification information used for access restriction in the base station.

### REFERENCE SIGNS

1: Mobile communication system
10: 5GC (CN)
100: UE
110: Wireless communicator
111: Receiver
112: Transmitter
120: Controller
200: gNB, donor node, base station
210: Wireless communicator
211: Receiver
212: Transmitter
220: Network communicator
230: Controller
200S: Macrocell
300: IAB node (relay node)
310: Wireless communicator
311: Receiver
312: Transmitter
320: Controller
300M: Mobile IAB node (mobile relay node)
300S: Mobile IAB cell

1. A communication control method used in a cellular communication system, the communication control method comprising:
transmitting, by a user equipment, a first connection request notification to a network node, the first connection request notification indicating a desire to connect to a cell of a mobile relay node; and
transmitting, by the network node, a first message to the user equipment in response to receiving the first connection request notification, the first message comprising a measurement configuration that enables the user equipment to measure the cell.

2. The communication control method according to claim 1, further comprising:
transmitting, by the network node, a second message to the user equipment, the second message comprising first connection request notification configuration information indicating configuration information configured to transmit the first connection request notification; and
receiving, by the user equipment, the second message,
wherein the transmitting of the first connection request notification comprises transmitting, by the user equipment, the first connection request notification in accordance with the first connection request notification configuration information.

3. The communication control method according to claim 1, wherein
the transmitting of the first connection request notification comprises transmitting, by the user equipment, the first connection request notification when determining that connection to the cell is possible.

4. The communication control method according to claim 1, wherein
the first connection request notification comprises at least any selected from the group consisting of a frequency used in the cell, a cell ID of the cell, and identification information used for access restriction in the cell.

5. A communication control method used in a cellular communication system, the communication control method comprising:
transmitting, by a user equipment, a second connection request notification to a cell of a mobile relay node, the second connection request notification indicating a desire to connect to a network node; and
transmitting, by the cell, a third message to the user equipment in response to receiving the second connection request notification, the third message comprising a measurement configuration that enables the user equipment to measure the network node.

6. The communication control method according to claim 5, further comprising:
transmitting, by the cell, a fourth message to the user equipment, the fourth message comprising second connection request notification configuration information indicating configuration information configured to transmit the second connection request notification; and
receiving, by the user equipment, the fourth message,
wherein the transmitting of the second connection request notification comprises transmitting, by the user equipment, the second connection request notification in accordance with the second connection request notification configuration information.

7. The communication control method according to claim 5, wherein
the transmitting of the second connection request notification comprises transmitting, by the user equipment, the second connection request notification when determining that connection to the network node is possible.

8. The communication control method according to claim 5, wherein
the second connection request notification comprises at least any selected from the group consisting of a frequency used in the network node, a cell ID of the network node, and identification information used for access restriction in the network node.

9. A user equipment comprising:
a transmitter configured to transmit a first connection request notification to a network node, the first connection request notification indicating a desire to connect to a cell of a mobile relay node; and
a receiver configured to receive a first message from the network node, the first message comprising a measurement configuration that enables the user equipment to measure the cell.
